(19) United States
(12) Patent Application Publication
(10) Pub. No.: US 2019/0202598 A1
(43) Pub. Date: Jul. 4, 2019

(54) EASY LIFT RACK

(71) Applicant: DENNIS RAY DICKSON, ALEXANDRIA, LA (US)

(72) Inventor: DENNIS RAY DICKSON, ALEXANDRIA, LA (US)

(21) Appl. No.: 16/234,442

(22) Filed: Dec. 27, 2018

Related U.S. Application Data
(60) Provisional application No. 62/611,106, filed on Dec. 28, 2017.

(51) Int. Cl. B65D 19/44; B65D 19/42; B65G 1/02

(52) U.S. Cl. CPC B65D 19/44; B65D 19/42; B65G 1/02; B65D 2519/00796; B65D 2519/00781; B65D 2519/00059; B65D 2519/00562; B65D 2519/00815; B65D 2519/00024

(57) ABSTRACT

In the counter-top fabrication business, the biggest and most serious problem is the movement of material. The biggest reason for concern is that kitchen countertop pieces can weigh anywhere from 200 to 1200 pounds. The racks used to transport pieces are normally 4 to 8 inches tall off the ground which is just enough room for the forks of a forklift to raise the rack. Therefore, installers must squat all the way to the ground to lift the pieces. The invention we created is an easy lift rack raising the height of the countertop material as high as possible on the rack while still being able to travel safe. We have lifted the rack as high as possible to reach what OSHA calls the “power zone” for lifting. Our rack can easily be moved around with a forklift, and allows for safe and easy loading/unloading of countertop material.

### BACKGROUND

In the counter top fabrication business, the biggest and most serious problem is the movement of material. Material must be moved from slab racks to machines for fabrication, then onto a delivery vehicle to be brought to the end user's location and lastly, removed from the vehicle to be installed. The biggest reason for concern is that kitchen countertop pieces, on average, weigh 200 to 400 pounds while islands can weigh up to 1200 pounds. The racks used to transport pieces are normally 4 to 8 inches tall off the ground which is just enough room for the forks of a forklift to raise the rack. Therefore, installers must squat all the way to the ground to lift the pieces. We have been in the countertop fabrication business for the last ten years. Moving this material is a challenge in two ways: we must figure out how to move the material without causing injuries to employees, but also how to do it without breaking or damaging the material. The granite material comes in slabs that are 72 inches by 120 inches, and can weight up to 1200 pounds. Even after the slab is cut up into pieces, it can still weigh anywhere from 200 to 1200 pounds. After we receive the 1200-pound granite slabs from wholesalers, the next step is to lay it down on a saw to cut. A special boom on the forklift is made to handle that much weight. The slabs can be laid over with tension straps, or with a suction hoist hanging form the forklift crane. The last and least safe way to do this would be four men laying the slab down on the saw with their hands. Once the slab has been cut up on the saw, the pieces are then ready to move to the CNC, profiler, or work tables. The finished pieces are now loaded onto the rack on the truck or trailer or an easy lift rack in the shop. The rack can be loaded in the shop and the fully loaded rack can be moved to the trailer with the forklift making it a quick, safe, and easy process. Lastly, the pieces must be taken off the rack and into a home or business to be installed. Our rack deals with the last step in this process, making it quicker and much safer to move and remove pieces off the rack.

### BRIEF SUMMARY OF THE INVENTION

The invention we created is an easy lift rack. We have invented a rack that raises the height of the countertop material as high as possible on the rack while still being able to travel safe. It raises the rack from 2 to 18 inches based on the end user's needs. We are lifting the rack as high as possible to get reach what OSHA calls the “power zone” for lifting. While the racks are customized to end user's needs, we want the lifting point as high as possible while keeping the top of rack low enough to ensure safe transportation. On top of not having to squat all the way down to pick up the material, there are additional benefits to raising the rack. If raised properly, the rack can be moved with a forklift and placed on a trailer, including those with 12-inch side rails. It also allows drop down pins in each of the four corners that go through holes on the trailer providing an extra degree of safety during transport. Lastly, when the rack is moved from the trailer back to the shop, wheels can quickly be installed by removing the extension pins. The standard racks in the countertop industry are 4 to 6 inches off the ground, designed just high enough so that the forks on a forklift can pick it up. This does not consider the person squatting down to 6 inches to lift 200 to 1200-pound pieces; our racks are designed to do just that. We have many heights and six different designs to accomplish this in accordance of the installer's needs. There are three considerations when dealing with this. First, we must decide which height will make the best possible outcome; the ideal height for the installer maximizes his “power zone.” Second, we must be low enough for installers attach straps to the top of the rack, securing the pieces. The average job has 5 to 15 different pieces. When one piece is moved off the rack to be installed, the straps must be reset to keep the pieces secure. Lastly, the height of the rack must allow clearance for the side rails on the trailer. Since the standard utility trailer has 12-inch side rails, the rack would need to also be 12 inches tall. At 12 inches, the material is 18 inches off the ground verses 6 inches, moving it into the “power zone.” This will also allow the rack to clear the side rails and fenders on a trailer ensuring that it can be loaded and unloaded properly. At this height, you will still be able to reach the safety straps as needed. Depending on user preference, the racks can be secured together three different ways: Nuts and bolts, U-bolts, or welded together.

### BRIEF DESCRIPTION OF DRAWINGS

FIG. 1. Side end-angle view of lift rack

FIG. 2. End view of lift rack

FIG. 3. Side view of lift rack

FIG. 4. Top view of lift rack

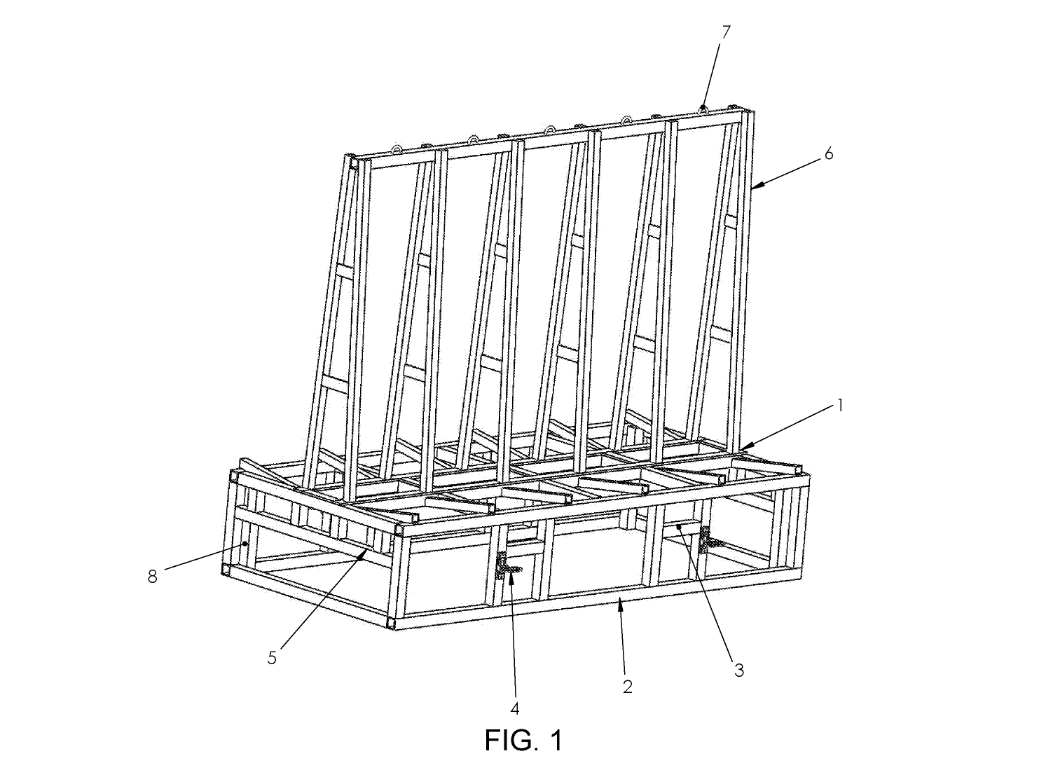

### FIG. 1

1) Location where countertop is stacked on rack
2) Base-upright which determines the final height of countertop material off the floor
3) Side forklift-mount
4) Fold-down step
5) End forklift-mount
6) Top upright of upper section of rack
7) Top hooks where mounting straps are attached
8) Corner tubing mounted to install drop-down legs during transportation or installing wheel assembly

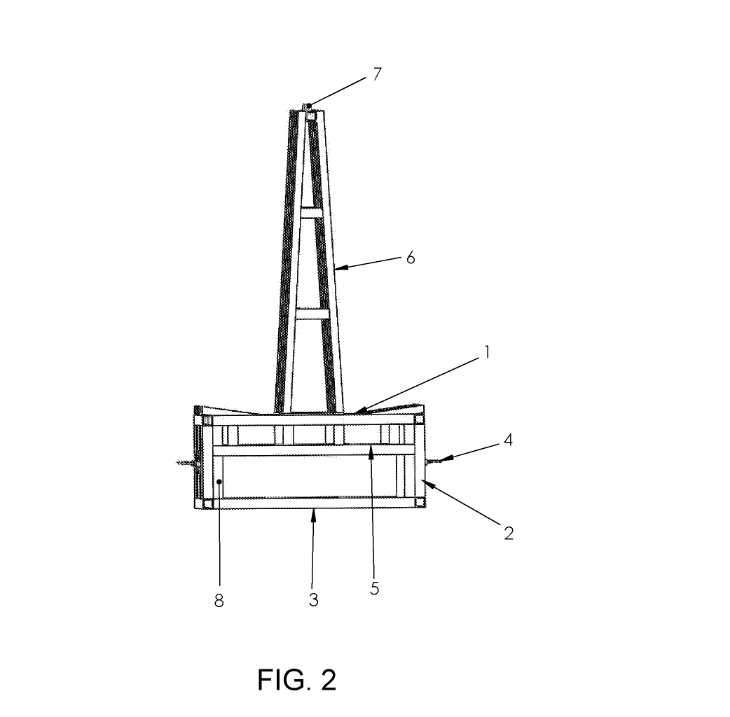

### FIG. 2

1) Location where countertop is stacked on rack
2) Base-upright which determines the final height of countertop material off the floor
3) Corner tubing mounted to install drop-down legs during transportation or installing wheel assembly
4) Fold-down step
5) End forklift-mount
6) Top upright of upper section of rack
7) Top hooks where mounting straps are attached
8) Corner tubing mounted to install drop-down legs during transportation or installing wheel assembly

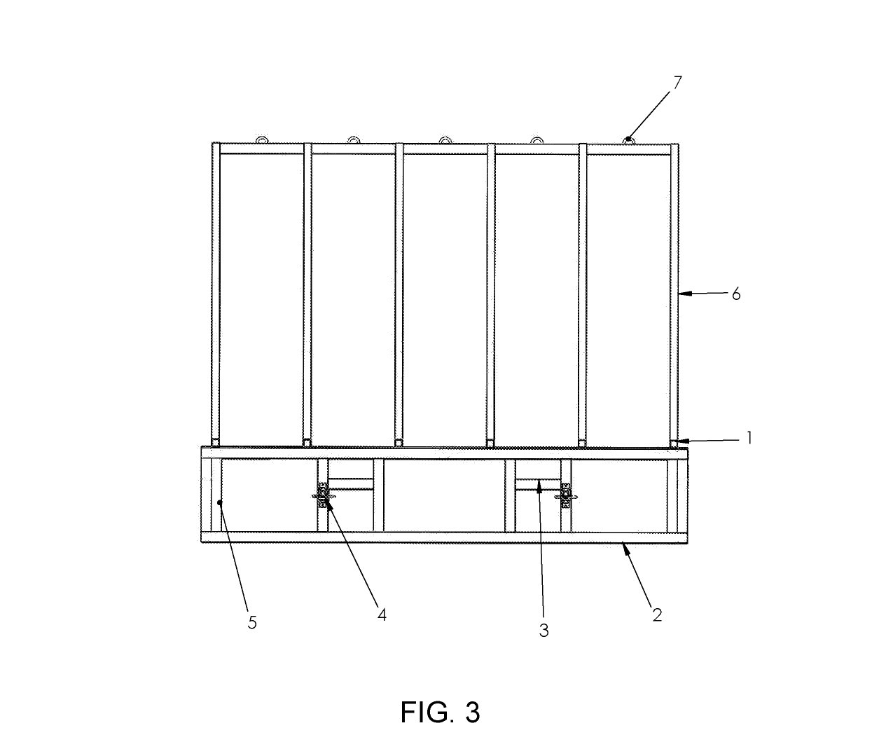

### FIG. 3

1) Location where countertop is stacked on rack
2) Base-upright which determines the final height of countertop material off the floor
3) Side forklift-mount
4) Fold-down step
5) End forklift-mount
6) Top upright of upper section of rack
7) Top hooks where mounting straps are attached
8) Corner tubing mounted to install drop-down legs during transportation or installing wheel assembly

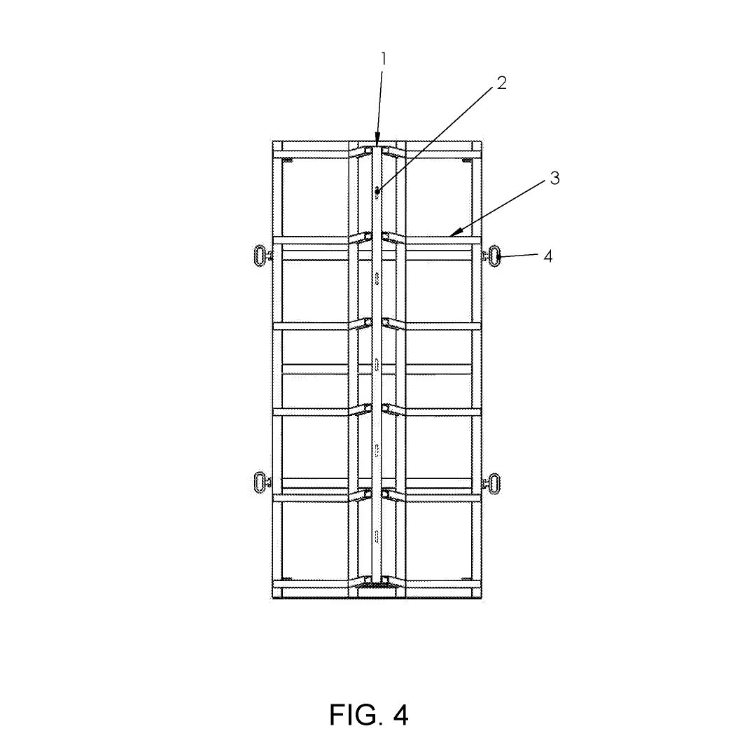

### FIG. 4

1) Location where countertop is stacked on rack
2) Top hooks where mounting straps are attached
3) Lower platform base
4) Fold-down step

1. A Easy Lift Rack, comprised: metal supports bolted and or welded together to lift rack off the ground to loading level in order to reach what OSHA calls the power zone for safe lifting.

2. A Easy Lift Rack in #1, further comprised: of sleeves in each corner to mount safety stops for use on trailers and wheels for use off-trailer.

3. A Easy Lift Rack, comprised: of metal supports bolted and or welded together to raise racks high enough to clear side rails of trailer.

4. A Easy Lift Rack in claim #3, comprised: of lift points for forklift to raise racks above side rails on trailers for safe and quick loading and unloading.
